(19) United States
(12) Patent Application Publication
(10) Pub. No.: US 2026/0158901 A1
(43) Pub. Date: Jun. 11, 2026

(54) ACTIVE CASTER

(71) Applicant: TOYOTA JIDOSHA KABUSHIKI KAISHA, Aichi-ken (JP)

(72) Inventor: Hirotaka KOMURA, Yokohama-shi (JP)

(73) Assignee: TOYOTA JIDOSHA KABUSHIKI KAISHA, Aichi-ken (JP)

(21) Appl. No.: 19/390,669

(22) Filed: Nov. 17, 2025

(30) Foreign Application Priority Data
Dec. 9, 2024 (JP) 2024-214403

(51) Int. Cl. B60K 7/00; B60B 33/00; B60K 17/04

(52) U.S. Cl. CPC B60K 7/0007; B60B 33/0068; B60K 17/043

(57) ABSTRACT

To provide an active caster adapted to suppress the decline in the driving performance. An active caster according to the present disclosure includes: a wheel; a first rotation transmission mechanism; and a second rotation transmission mechanism. A rotational force of a motor is transmitted to a rotation of the wheel about a pivot axis along a vertical axis via the first rotation transmission mechanism, the rotational force of the motor is transmitted to the rotation of the wheel about an axle via the first rotation transmission mechanism and the second rotation mechanism, and r/G>s holds true, where s>0 represents an offset of the axle from the pivot axis in a horizontal direction orthogonal to the axle, G represents a reduction ratio of the second rotation transmission mechanism, and r represents a radius of the wheel.

### CROSS REFERENCE TO RELATED APPLICATIONS

This application is based upon and claims the benefit of priority from Japanese patent application No. 2024-214403, filed on Dec. 9, 2024, the disclosure of which is incorporated herein in its entirety by reference.

### BACKGROUND

The present disclosure relates to an active caster.

Patent Literature 1 discloses a technique for suppressing sideslips of an autonomous mobile robot.
[Patent Literature 1] Japanese Unexamined Patent Application Publication No. Publication No. 2024-038433

### SUMMARY

In the case where the friction generated due to stationary steering is larger than the friction generated when tires are rolled, the rotational torque of the active caster is insufficient, and the driving performance of the active caster may decline.

The present disclosure has been made in view of the above background, and it is an object of the present disclosure to provide an active caster adapted to suppress decline in the driving performance.

An active caster according to the present disclosure includes:
a wheel;
a first rotation transmission mechanism; and
a second rotation transmission mechanism,
in which
a rotational force of a motor is transmitted to a rotation of a wheel about a pivot axis along a vertical axis via the first rotation transmission mechanism,
the rotational force of the motor is transmitted to the rotation of the wheel about an axle via the first rotation transmission mechanism and the second rotation transmission mechanism, and
r/G>s holds true, where s>0 represents an offset of the axle from the pivot axis in a horizontal direction orthogonal to the axle, G represents a reduction ratio of the second rotation transmission mechanism, and r represents a radius of the wheel.

According to the present disclosure, it is possible to provide an active caster which adapted to suppress decline in the driving performance.

The above and other objects, features and advantages of the present disclosure will become more fully understood from the detailed description given hereinbelow and the accompanying drawings.

### BRIEF DESCRIPTION OF DRAWINGS

FIG. 1 is a diagram for explaining an operation of an active caster according to a comparative example;

FIG. 2 is a diagram for explaining the problem of an active caster according to a comparative example;

FIG. 3 is a perspective view illustrating a configuration of an active caster according to a first embodiment;

FIG. 4 is a diagram for explaining a driving force transmission path of the active caster according to the first embodiment;

FIG. 5 is a diagram showing the active caster according to the first embodiment by graphic symbols; and

FIG. 6 is a diagram for explaining speed of the active caster and a direction of thrust according to the first embodiment.

### DESCRIPTION OF EMBODIMENTS

### Reference Example

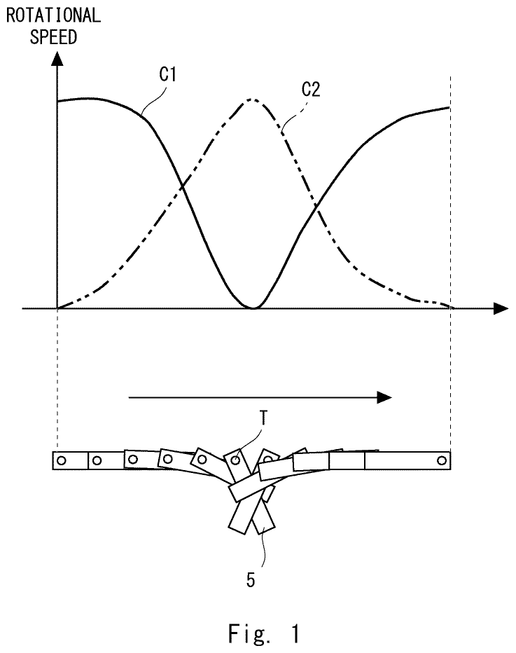

FIG. 1 is a diagram for explaining an example of an operation of an active caster according to a reference example. An active caster has a wheel 5 and a pivot axis T along a vertical axis. The wheel 5 is pivotally supported about the pivot axis T extending in the vertical direction. The axle of the wheel 5 is displaced in the horizontal direction perpendicular to the axial direction of the axle with respect to the pivot axis T. That is, when viewed from above the wheel 5, the pivot axis T is provided at a position different from the ground contact point of the wheel 5. An active caster may be installed in an omnidirectional mobile vehicle.

The lower diagram of FIG. 1 shows an example of the movement of an active caster in the direction of the arrow. The wheel 5 pivots about the axle while rotating about the pivot axis T. The horizontal axis in the upper diagram of FIG. 1 corresponds to the position of the wheel 5 in the lower diagram of FIG. 1. Curve C1 shows the rotational speed of the wheel 5 about the axle. Curve C2 shows the rotational speed of the wheel 5 about the pivot axis T.

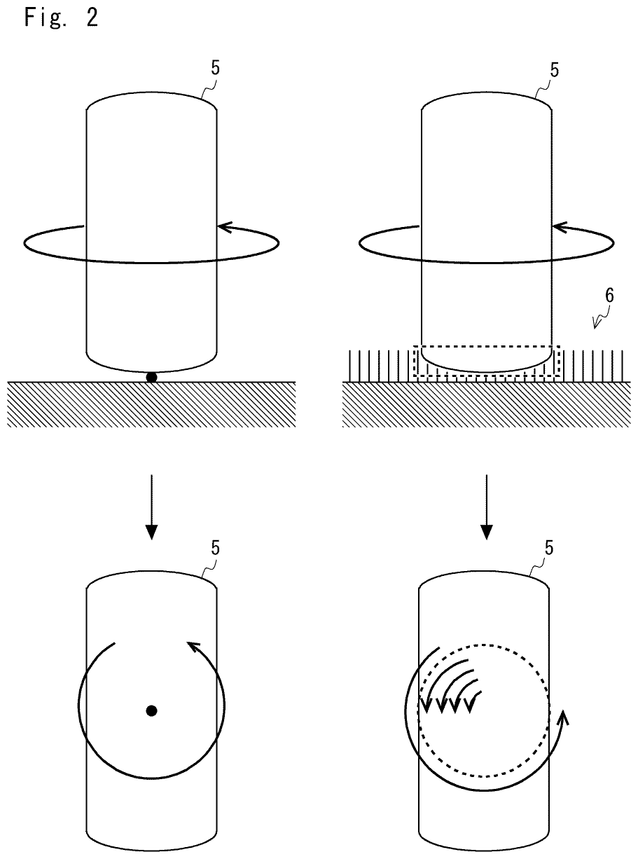

With reference to FIG. 2, the problem of the active caster according to the reference example will be described. The upper-left diagram of FIG. 2 shows a schematic front view of the wheel 5, in which normally, the wheel 5 contacts the floor surface at substantially one point. The lower-left diagram of FIG. 2 shows a schematic top view of the wheel 5. The arcuate arrows in the upper left and lower left diagrams of FIG. 2 represent the pivoting motion of the wheel 5. In the case where the wheel 5 contacts the floor surface at one point, the sliding of the wheel 5 during pivoting is small.

Referring to the upper-right diagram of FIG. 2, in the case where there is a rug 6 (e.g., carpet) made of a flexible material disposed on the floor surface, the wheel 5 contacts the rug 6 in the area indicated by the dotted line in FIG. 2. In this case, the wheel 5 slides largely, as shown in the lower-right diagram of FIG. 2. The arcuate arrow inside the area surrounded by the dotted line represents the sliding of the wheel 5.

On the other hand, the resistance to rotation of the wheel 5 about the axle is considered to be relatively small even in the case where the wheel 5 travels on the rug 6. Since the difference between the resistance when pivoting the wheel 5 and the resistance when rotating the wheel 5 is not taken into account in the active caster according to the comparative example, there is room to improve the driving performance of the active caster.

The inventors of the present application have come up with an embodiment based on the above study. The embodiment will be described below.

### First Embodiment

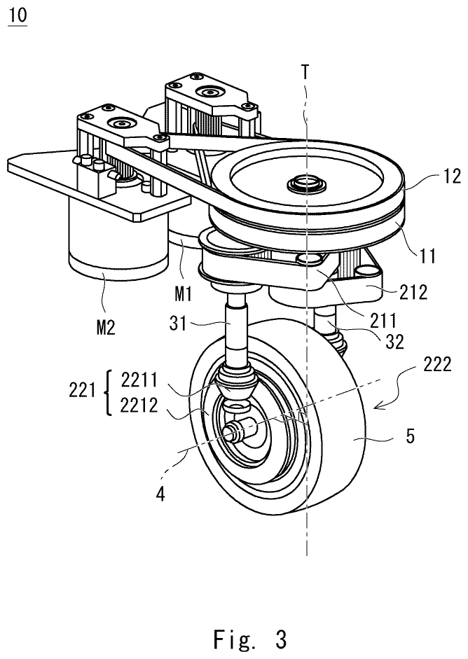

FIG. 3 illustrates a perspective view of an active caster 10 according to a first embodiment. The active caster 10 includes motors M1 to M2, reducers 211 to 212, reducers 221 to 222, output shafts 31 to 32, an axle 4, and the wheel 5. Reducers 11 to 12 correspond to a first rotation transmission mechanism described above, and the reducers 211 to 212 and the reducers 221 to 222 correspond to a second rotation transmission mechanism described above.

The motors M1 and M2 may be motors of the same performance.

The reducer 11 includes a timing belt hung on an output shaft and a driven pulley of the motor M1. The reducer 12 includes a timing belt hung on an output shaft and a driven pulley of the motor M2. The driven pulley of the reducer 11 and the driven pulley of the reducer 12 are supported to be pivotable about the pivot axis T. The reduction ratio of the reducer 11 may be the same as the reduction ratio of the reducer 12.

The reducer 211 includes a pulley to which a driven pulley of the reducer 11 is fixed on the upper part thereof, a pulley to which an output shaft 31 is fixed, and a timing belt hung on these pulleys. The reducer 211 may further include an idling pulley.

The reducer 212 includes a pulley to which a driven pulley of the reducer 12 is fixed to the upper part thereof, a pulley fixed to the upper part of an output shaft 32, and a timing belt hung on these pulleys. The reducer 212 may further include an idling pulley. The reduction ratio of the reducer 211 may be the same as the reduction ratio of the reducer 212. The reducers 211 and 212 are also referred to as belt pulley reducers.

The reducer 221 includes a bevel gear 2211 fixed to the lower part of the output shaft 31 and a bevel gear 2212 fixed to one side of the wheel 5. The bevel gear 2211 and the bevel gear 2212 mesh. The reducer 222, like the reducer 221, also includes two bevel gears that mesh with each other, with one bevel gear fixed to the lower part of the output shaft 32 and the other bevel gear fixed to the other side of the wheel 5. The reduction ratio of the reducer 221 may be the same as the reduction ratio of the reducer 222. The reducers 221 and 222 are also referred to as bevel gear reducers.

The wheel 5 is rotatably supported about a pivot axis T1. The support member supporting the wheel 5 or the axle 4 may be considered as the pivot axis T.

For example, when the motors M1 and M2 rotate at the same speed in the same direction, the output shafts 31 and 32 also rotate at the same speed in the same direction. Since the direction in which the output shaft 31 rotates the wheel 5 about the axle 4 is opposite to the direction in which the output shaft 32 rotates the wheel 5 about the axle 4, the wheel 5 rotates about the pivot axis T, not about the axle 4. On the other hand, when the motors M1 and M2 rotate at the same speed in the opposite directions, the output shafts 31 and 32 rotate at the same speed in the opposite directions, and the wheel 5 rotates about the axle 4, not about the pivot axis T.

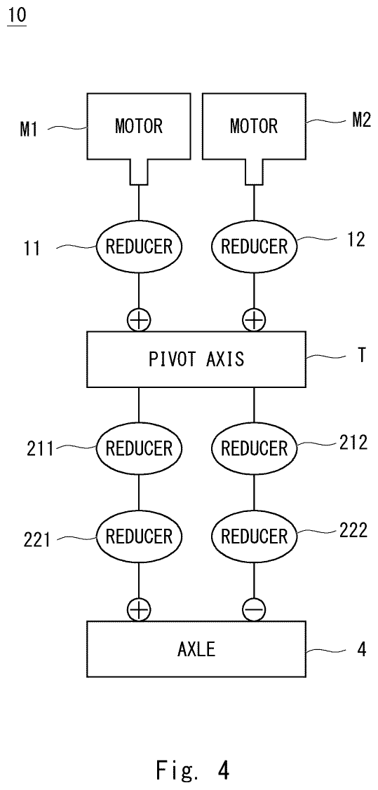

A driving force transmission path of the active caster 10 is shown in FIG. 4. The sum of the rotational force of the motor M1 transmitted through the reducer 11 and the rotational force of the motor M2 transmitted through the reducer 12 is transmitted to the rotation of the wheel 5 about the pivot axis T. The difference between the rotational force of the motor M1 transmitted through the reducer 11, the reducer 211, and the reducer 221 and the rotational force of the motor M2 transmitted through the reducer 12, the reducer 212, and the reducer 222 is transmitted to the rotation of the wheel 5 about the axle 4.

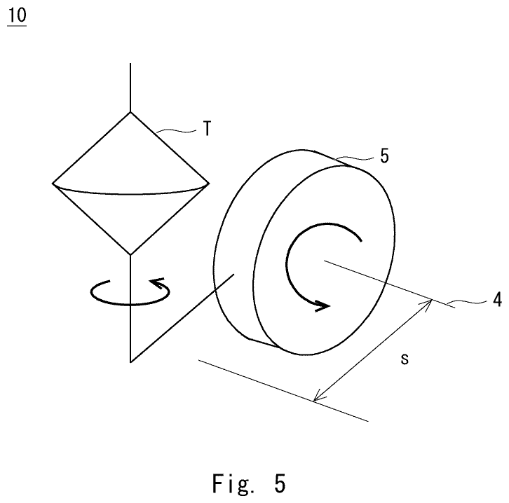

FIG. 5 is a diagram showing the active caster 10 by graphic symbols. The active caster 10 includes the pivot axis T and the axle 4 as described above. Let s (s>0) be the offset from the pivot axis T of the axle 4 in the direction orthogonal to the extending direction of the axle 4.

Referring again to FIG. 4, G1 represents the reduction ratio of the reducers 11 and 12, G21 represents the reduction ratio of the reducers 211 and 212, and G22 represents the reduction ratio of the reducers 221 and 222. The rotational speed transmission ratio from the motors M1 and M2 to the pivot axis T is expressed as G1/s. The rotational speed transmission ratio from the motors M1 and M2 to the axle 4 is expressed as G1×G21×G22÷r, where r is the radius of the wheel 5.

G21×G22 corresponds to G described above. The rotational speed transmission ratio from the motors M1 and M2 to the axle 4 is also expressed as G1×G÷r.

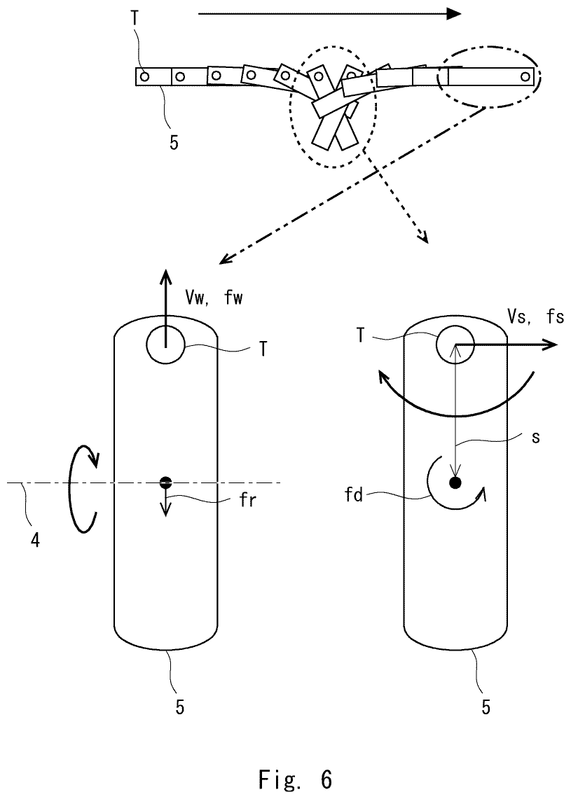

The direction of the translational velocity of the wheel 5 located in the area surrounded by the double-dashed line in FIG. 6 is different from the direction of the translational velocity of the wheel 5 located in the area surrounded by the dotted line. The arrows represent the direction in which the wheel 5 moves, as in FIG. 1.

The lower-left diagram of FIG. 6 shows the wheel 5 located in the area surrounded by the double-dashed line in FIG. 6. In the lower-left diagram of FIG. 6, the vertical direction corresponds to the front-rear direction of the wheel 5, and the left-right direction corresponds to the lateral direction of the wheel 5. The arcuate arrow represents the rotation of the wheel 5 about the axle 4. The translational velocity v_{w} of the wheel 5 and the thrust f_{w} generated in the wheel 5 are oriented along the front-rear direction of the wheel 5. The rolling resistance fᵣ is generated in the direction opposite to the direction of the translational velocity v_{w} and the thrust f_{w}.

The lower-right diagram of FIG. 6 shows the wheel 5 located in the area surrounded by the dotted line in the upper diagram of FIG. 6. The clockwise arrow represents the rotation of the wheel 5 about the pivot axis T. The translational velocity vₛ of the wheel 5 and a thrust fₛ generated in the wheel 5 are oriented along the lateral direction of the wheel 5. A frictional force f_{d} is generated in the direction opposite to the direction of the rotation of the wheel 5 about the pivot axis T.

Assuming that the rotational speed of the motors M1 and M2 is ωₘ, v_{w} and vₛ are expressed by the following Expressions.

$$\begin{matrix}[ Expression 1 ] & \\ {v}_{w} = \frac{r {ω}_{m}}{{G}_{1} {G}_{21} {G}_{22}} & ( 1 )\end{matrix}$$

$$\begin{matrix}[ Expression 2 ] & \\ {v}_{s} = \frac{s {ω}_{m}}{{G}_{1}} & ( 2 )\end{matrix}$$

Similarly, assuming that the torque of the motors M1 and M2 is τₘ, f_{w} and fₛ are expressed by the following Expressions.

$$\begin{matrix}[ Expression 3 ] & \\ {f}_{w} = \frac{{G}_{1} {G}_{21} {G}_{22}}{r} {τ}_{m} & ( 3 )\end{matrix}$$

$$\begin{matrix}[ Expression 4 ] & \\ {f}_{s} = \frac{{G}_{1}}{s} {τ}_{m} & ( 4 )\end{matrix}$$

The values of G21, G22, s, and r of the active caster 10 are designed to satisfy the following Expression.

$$\begin{matrix}[ Expression 5 ] & \\ \frac{r}{{G}_{21} {G}_{22}} > s & ( 5 )\end{matrix}$$

Assuming that G21×G22=G, Expression (5) can be expressed as r/G>s. In the active caster 10, v_{w}>vₛ and f_{w}<fₛ hold true. In the active caster 10, the thrust fₛ is relatively large, and therefore it is possible to suppress decline in the driving performance of the wheel 5 caused by the rotation of the wheel 5 about the pivot axis T, that is, that is, the friction generated due to stationary steering of the wheel 5.

It should be noted that the present disclosure is not limited to the above-described embodiment, and may be appropriately modified without departing from the purport.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An active caster comprising:
a wheel;
a first rotation transmission mechanism; and
a second rotation transmission mechanism,
wherein
a rotational force of a motor is transmitted to a rotation of a wheel about a pivot axis along a vertical axis via the first rotation transmission mechanism,
the rotational force of the motor is transmitted to the rotation of the wheel about an axle via the first rotation transmission mechanism and the second rotation transmission mechanism, and
r/G>s holds true, where s>0 represents an offset of the axle from the pivot axis in a horizontal direction orthogonal to the axle, G represents a reduction ratio of the second rotation transmission mechanism, and r represents a radius of the wheel.

2. The active caster according to claim 1, wherein the active caster travels on a floor on which a rug is disposed.

3. The active caster according to claim 1, wherein
the second rotation transmission mechanism includes a belt pulley reducer and a bevel gear reducer, and
the reduction ratio of the second rotation transmission mechanism is expressed as a product of a reduction ratio of the belt pulley reducer and a reduction ratio of the bevel gear reducer.

4. The active caster according to claim 1, wherein v_{w}>vₛ holds true, where v_{w} represents a translational velocity of the wheel caused by the rotation of wheel about the axle and vₛ represents a translational velocity of the wheel caused by the rotation of the wheel about pivot axis.

5. The active caster according to claim 1, wherein the active caster is installed in an omnidirectional mobile vehicle.
